(19) United States
(12) Patent Application Publication
(10) Pub. No.: US 2018/0289082 A1
(43) Pub. Date: Oct. 11, 2018

(54) PRINTABLE HEATERS FOR WEARABLES

(71) Applicant: E I DU PONT DE NEMOURS AND COMPANY, Wilmington, DE (US)

(72) Inventors: MICHAEL ZANONI BURROWS, RALEIGH, NC (US); JOHN C. CRUMPTON, BAHAMA, NC (US); JEFFREY J. G. DEE, SAN JOSE, CA (US); DANIEL ANEURIN INNS, PALO ALTO, CA (US); MARK ALLAN LAMONTIA, LANDENBERG, PA (US); MEHRDAD MEHDIZADEH, AVONDALE, PA (US)

(21) Appl. No.: 15/935,769

(22) Filed: Mar. 26, 2018

Related U.S. Application Data
(60) Provisional application No. 62/482,374, filed on Apr. 6, 2017.

(51) Int. Cl. A41D 13/005; H05B 3/03; H05B 3/12; A41D 31/00; A41D 31/02

(52) U.S. Cl. CPC A41D 13/0051; H05B 3/03; H05B 3/12; A41D 31/0005; A41D 3/00; H05B 2203/013; H05B 2203/036; A41D 2400/22; A41D 31/02

(57) ABSTRACT

This invention provides improved printed heaters for use in wearable garments. The improvement comprises replacing the single large area resistive material layer with a number of small patches of resistive material, i.e., replacing the single large area heater with a number of smaller individual heaters. Printing of the resistive material is facilitated since the area of each resistive material patch is greatly reduced. In addition, some embodiments enable the opportunity to provide a breathable heater.

### FIELD OF THE INVENTION

This invention is directed to improved printable heaters in wearable garments.

### BACKGROUND OF THE INVENTION

There is increasing interest in providing heatable wearable garments. Currently typical commercialized heated jackets are heated by resistance wires. These jackets have the advantage that the areas between the wires allow the fabric to breathe. However, they have the disadvantage that the presence of the wires renders the jackets uncomfortable. An alternative is to use heaters with printed components which would provide greater comfort to the wearer. One component of such a heated garment is a layer of resistive material, e.g., carbon, which serves as the resistive heating element. Such a layer could cover a significant portion of the garment. It is difficult to print a large area resistive material layer with appropriate thickness and uniformity using currently available compositions. Such a large printed layer could also result in that portion of the garment not being breathable and therefore a source of discomfort for the wearer. There is a need for improved heaters for wearable garments.

### SUMMARY OF THE INVENTION

This invention provides improved printed heaters for use in wearable garments. The improvement comprises replacing the single large area resistive material layer with a number of small patches of resistive material, i.e., replacing the single large area heater with a number of smaller individual heaters. Printing of the resistive material is facilitated since the area of each resistive material patch is greatly reduced. In addition, some embodiments enable the opportunity to provide a breathable heater.

Therefore, the invention provides a wearable garment containing a heater, the heater comprising a plurality of individual heaters disposed in an array.

In one embodiment the array of individual heaters covers at most 90% of the overall area of the heater with the remaining area comprising permeable material.

In one embodiment, each individual heater comprises printed bus bars, printed electrodes and a printed resistive material to serve as a resistive heating element. In one such embodiment, the electrodes are printed in an interdigitated pattern to provide two sets of finger-like electrodes with the printed layer of resistive material contiguous to the electrodes. In some embodiments, the printed electrodes and bus bars are silver electrodes and silver bus bars and the printed layer of resistive material is a layer of carbon. In other embodiments, the printed electrodes and bus bars are copper electrodes and copper bus bars and the printed layer of resistive material is a layer of carbon. In still other embodiments, the printed electrodes and bus bars are silver-silver chloride, gold or aluminum.

In a second kind of embodiment, a single set of bus bars connects to all the printed electrodes providing voltages across the printed resistive material of all the individual heaters. In some embodiments the printed electrodes are silver electrodes; in other embodiments they are copper electrodes. In some embodiments the printed resistive layer is a layer of carbon.

In a third kind of embodiment, only two printed electrodes provide voltages across the printed resistive material of all the individual heaters.

### BRIEF DESCRIPTION OF THE FIGURES

FIG. 1 illustrates one embodiment of a printed heater for wearables, the heater comprising a plurality of individual heaters disposed in an array covering less than 90% of the overall area of the heater with the remaining area comprising permeable material.

FIG. 2 illustrates another embodiment of a printed heater for wearables, the heater comprising a plurality of individual heaters disposed in an array covering less than 90% of the overall area of the heater with the remaining area comprising permeable material.

FIG. 3 illustrates an embodiment of a heater for wearables, the individual heaters comprising printed resistive material strips between pairs of interdigitated electrodes and exposed substrate between the individual heaters.

FIG. 4 illustrates one embodiment of a heater for wearables comprising printed resistive patches with spaces between them similar in size to the patches, wherein the patches and spaces are arranged in a checkerboard-like pattern.

FIG. 5 illustrates a second embodiment of a heater of the type of heater for wearables illustrated in FIG. 4 comprising printed resistive patches with spaces between them, wherein the size of the spaces has been decreased considerably and is a small fraction of the size of the patches.

FIG. 6 illustrates a heater for wearables with two spiral electrodes and patches of resistive material printed along a number of radii.

### DETAILED DESCRIPTION OF THE INVENTION

The invention relates to improved printed heaters for use in wearable garments. The improvement results from the use of a number of small patches of resistive material each of which serves as an individual heater instead of a single heater with a large area resistive material layer. The ability to print numerous small patches of resistive material results in more uniform areas of resistive material and therefore improved performance of the individual heaters and the heater comprising these individual heaters. One embodiment has the heater comprising a plurality of individual heaters disposed in an array covering at most 90% of the overall area of the heater. Another embodiment has the heater comprising a plurality of individual heaters disposed in an array covering at most 75% of the overall area of the heater. Yet another embodiment has the heater comprising a plurality of individual heaters disposed in an array covering at most 50% of the overall area of the heater.

When the substrate upon which the heater is printed is permeable, the heater has the additional advantage of being breathable in the sense that air and moisture can pass through. The regions of the substrate not covered by the individual heaters, i.e., the area between the individual heaters, is permeable and breathable. This can provide additional comfort to the wearer. The wearable garment itself may be comprised of a permeable fabric upon which the heater comprising the individual heaters is printed or the heater may be printed on a permeable polymer substrate which is attached to the garment. Openings can be made in the regions of the substrate not covered by the individual heaters, i.e., the area between the individual heaters, to provide additional breathability if the substrate is permeable or to provide breathability if the substrate is not permeable. As used herein, “two bus bars” is used to refer to printed conductors that connect to and provide voltages to the printed electrodes. There are two bus bars for each heater with a voltage applied across them. In some embodiments it may be convenient to separate a bus bar into separate portions. Such embodiments are included in the “two bus bar” usage. Each individual heater comprises a patch of printed resistive material that serves as a resistive heating element for that individual heater. Each individual heater further comprises printed electrodes to provide a voltage across the resistive patch. In one embodiment, the electrodes are printed in an interdigitated pattern to provide two sets of finger-like electrodes with the printed resistive material contiguous to the electrodes. The two sets of interdigitated electrodes may supply voltages to all the resistive patches. Alternatively, each individual heater may have its own set of electrodes. Typically, a resistive patch is contiguous to one electrode from each set of interdigitated electrodes. Alternatively, a resistive patch may be contiguous to more than one electrode from each set of interdigitated electrodes. Typically, all the electrodes in the heater from one set of interdigitated electrodes are connected to one bus bar and all the electrodes from the other set of interdigitated electrodes are connected to a second bus bar. Alternatively, each individual heater may have its own set of bus bars.

The electrodes and any bus bars can be printed onto the substrate before or after the resistive material patches.

The electrodes and bus bars referred to herein are formed from polymer thick film pastes containing the metal, i.e., printed silver electrodes and bus bars are formed using polymer thick film silver pastes. The resistive material is also printed using a polymer thick film paste, i.e. when the printed resistive material is printed carbon it is formed using a polymer thick film carbon paste. When using polymer thick film pastes, the polymer is an integral part of the final composition, i.e., the electrode, the bus bar or the resistive material.

Some of the above embodiments will be discussed further with reference to the Figures.

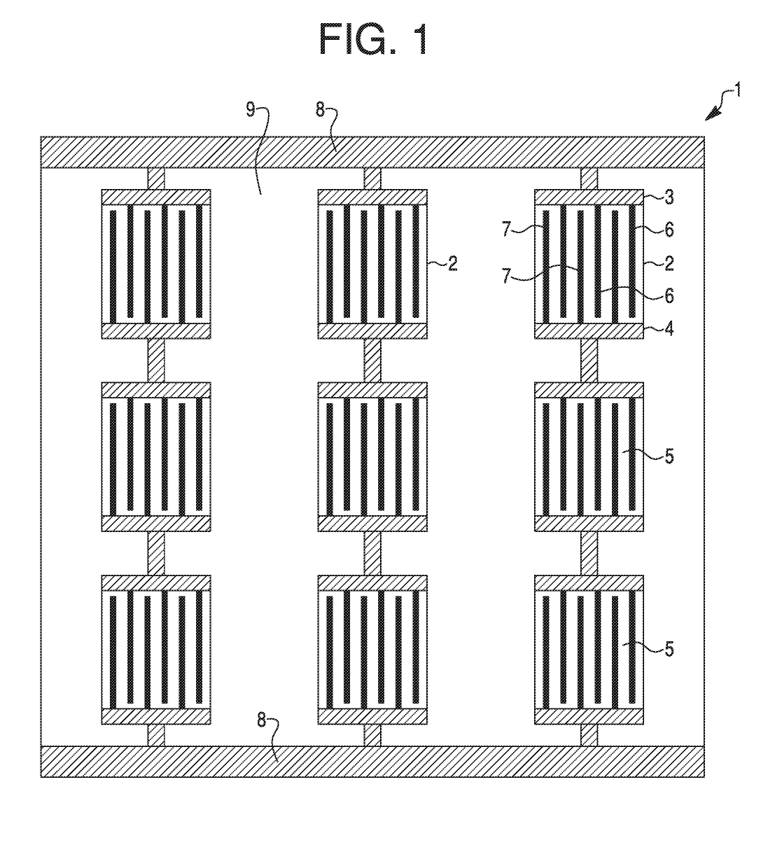

FIG. 1 illustrates a heater containing individual heaters each comprising printed bus bars, a printed resistive material patch and electrodes printed in an interdigitated pattern to provide two sets of finger-like electrodes all printed on a substrate. The heater 1 is shown with nine individual heaters 2 to provide a clear view of the heater construction. Each individual heater is comprised of a pair of bus bars 3 and 4 and a patch of resistive material 5. Each individual heater is further comprised of electrodes printed in an interdigitated pattern to provide two sets of finger-like electrodes with one set of electrodes 6 attached to bus bar 3 and the other set of electrodes 7 attached to bus bar 4. The resistive material 5 is contiguous to the electrodes 6 and 7. The bus bars 8 supply voltages to the individual bus bars 3 and 4. The region 9 of the substrate, i.e., the area between the individual heaters, is exposed. If the substrate is permeable and breathable this provides a breathable area in the heater. Heaters of this type with a larger number of smaller individual heaters and correspondingly smaller patches of resistive material would be constructed in the same manner.

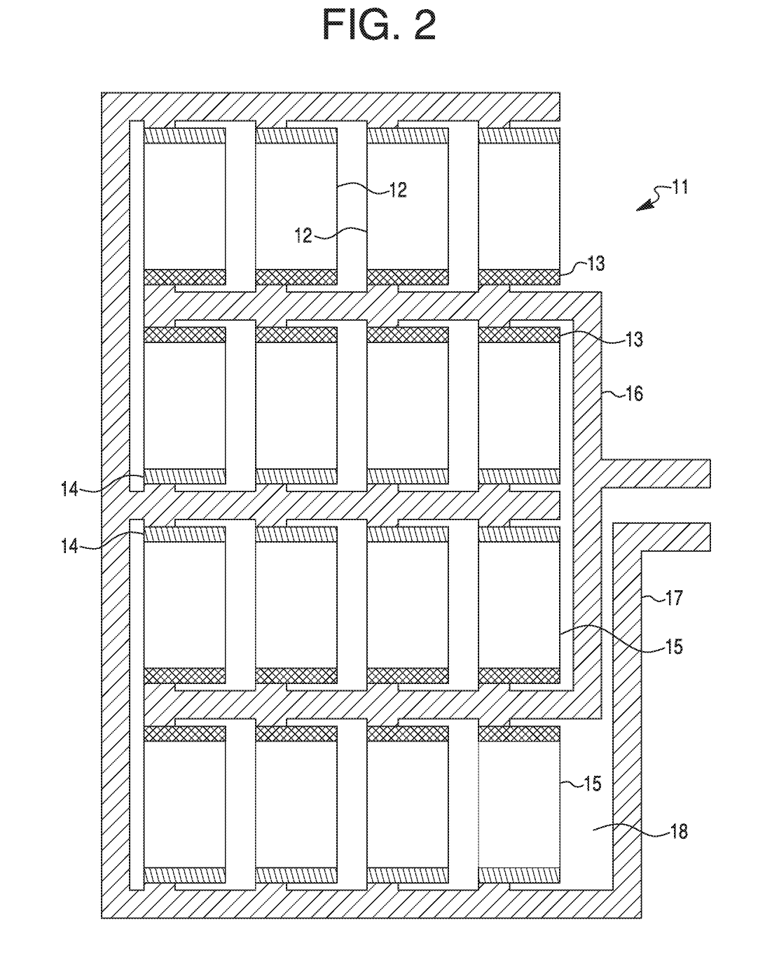

FIG. 2 illustrates another heater containing individual heaters each comprising printed bus bars, a printed resistive material patch and electrodes printed in an interdigitated pattern to provide two sets of finger-like electrodes all printed on a substrate. This heater has an alternative way of providing voltage to the individual bus bars. The heater 11 is shown with sixteen individual heaters 12 to provide a clear view of the heater construction. Each individual heater is comprised of a pair of bus bars 13 and 14 and a patch of resistive material 15. Each individual heater is further comprised of electrodes printed in an interdigitated pattern to provide two sets of finger-like electrodes with one set of electrodes attached to bus bar 13 and the other set of electrodes attached to bus bar 14. However, in the embodiment shown the electrodes would be deposited first and the patch of resistive material 15 covers the interdigitated electrodes. The printed resistive material 15 is contiguous to the electrodes. The connecting conductors 16 and 17 supply voltages to the individual bus bars 13 and 14. The region 18 of the substrate, i.e., the area not covered by the individual heaters, is exposed. If the substrate is permeable and breathable this provides a breathable area in the heater. Heaters of this type with a larger number of smaller individual heaters and correspondingly smaller patches of resistive material would be constructed in the same manner.

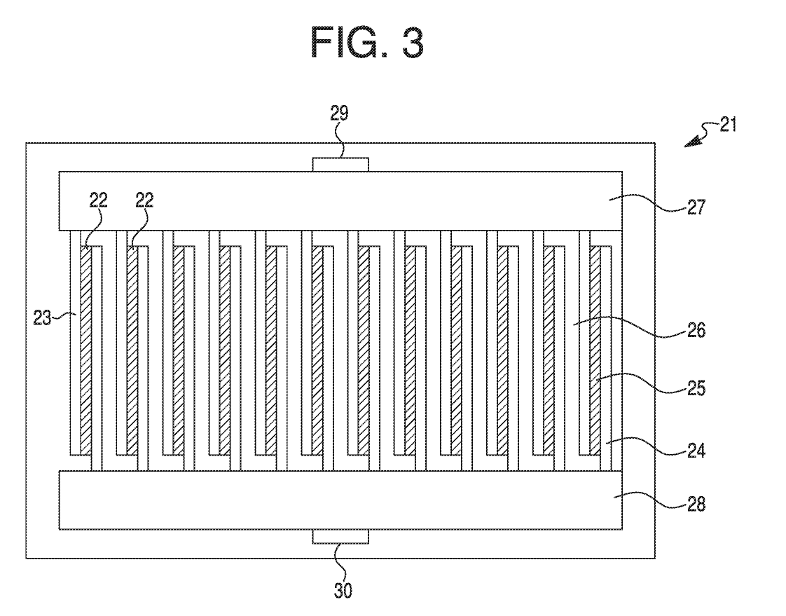

FIG. 3 illustrates a heater comprising a substrate, electrodes printed in an interdigitated pattern to provide two sets of electrodes consisting of finger-like electrodes each of a given width, two printed bus bars, wherein the first set of electrodes is connected to one bus bar and the second set of electrodes is connected to the other bus bar to provide an array of interdigitated electrodes between the two bus bars; and patches of resistive material in the form of strips printed parallel to the finger-like electrodes, all printed on a substrate. Individual heaters each comprise an electrode from each of the two sets of electrodes and a strip of resistive material. The heater 21 is shown with twelve individual heaters 22. Individual heaters 22 each comprise two electrodes, one 23 from one set of electrodes and a second 24 from the other set of electrodes, and a strip of resistive material 25. Each resistive material strip 25 has a width at least equal to the distance between neighboring electrodes so that each resistive material strip is contiguous to one finger-like electrode from the first set of electrodes and one finger-like electrode from the second set of electrodes and a width no greater than twice the width of a finger-like electrode plus the distance between neighboring electrodes, wherein each resistive material strip extends along the length of the two electrodes to which it is contiguous to form an individual heater with the regions between individual heaters comprising exposed substrate 26. If the substrate is permeable and breathable this provides a breathable area in the heater. Openings can be made in the regions of the substrate not covered by the individual heaters, i.e., the area between the individual heaters exposed substrate 26, to provide additional breathability if the substrate is permeable or to provide breathability if the substrate is not permeable.

In various embodiments the distance between neighboring electrodes may be decreased or increased. The two bus bars 27 and 28 provide voltage to the two sets of electrodes 23 and 24, respectively. the electrodes and the bus bars can be printed onto the substrate before or after the resistive material strips. The terminals 29 and 30 provide voltage to bus bars 27 and 28, respectively. The bus bars as shown are rectangular with a length and a width. For improved performance, the bus bar can be tapered such that the width of the bus bar is decreased along its length away from the terminal.

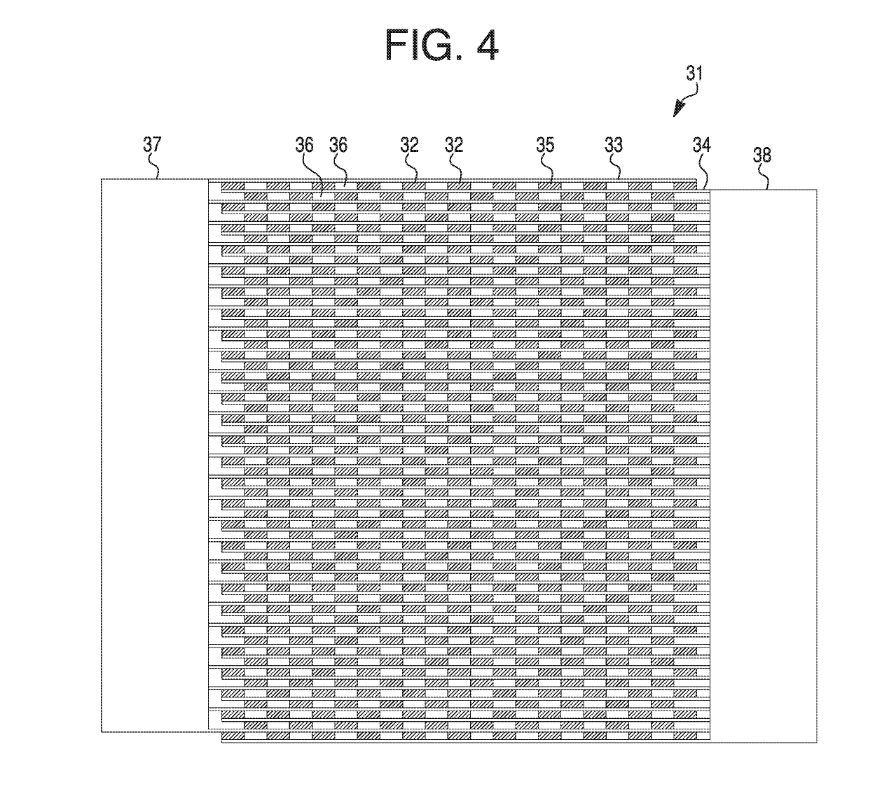

FIG. 4 illustrates one embodiment of a heater for wearables comprising printed resistive patches with spaces between them similar in size to the patches wherein the patches and spaces are arranged in a checkerboard-like pattern, the heater comprising two printed bus bars, electrodes printed in an interdigitated pattern to provide two sets of finger-like electrodes with one set connected to one bus bar and the other set connected to the other bus bar and an array of patches of printed resistive material all printed on a substrate. The heater 31 is shown with four hundred seventythree individual heaters 32. The individual heaters 32 each comprise two electrodes, one 33 from one set of electrodes and a second 34 from the other set of electrodes, and a patch of resistive material 35. Between each pair of neighboring finger-like electrodes 33 and 34 are a series of the resistive material patches 35 contiguous to both electrodes of the pair. The series of resistive material patches 35 are separated by spaces 36 both along the length of the pairs of neighboring electrodes and between neighboring series of resistive patches. As shown in FIG. 4, the spaces 36 separating the resistive material patches 35 are similar in size to the resistive material patches such that the total array of resistive material patches and spaces forms a checkerboard-like pattern. If the substrate is permeable and breathable the spaces 36 provide a breathable area in the heater. Openings can be made in the spaces 36 to provide additional breathability if the substrate is permeable or to provide breathability if the substrate is not permeable. Bus bars 37 and 38 provide voltage to the two sets of electrodes 33 and 34 respectively.

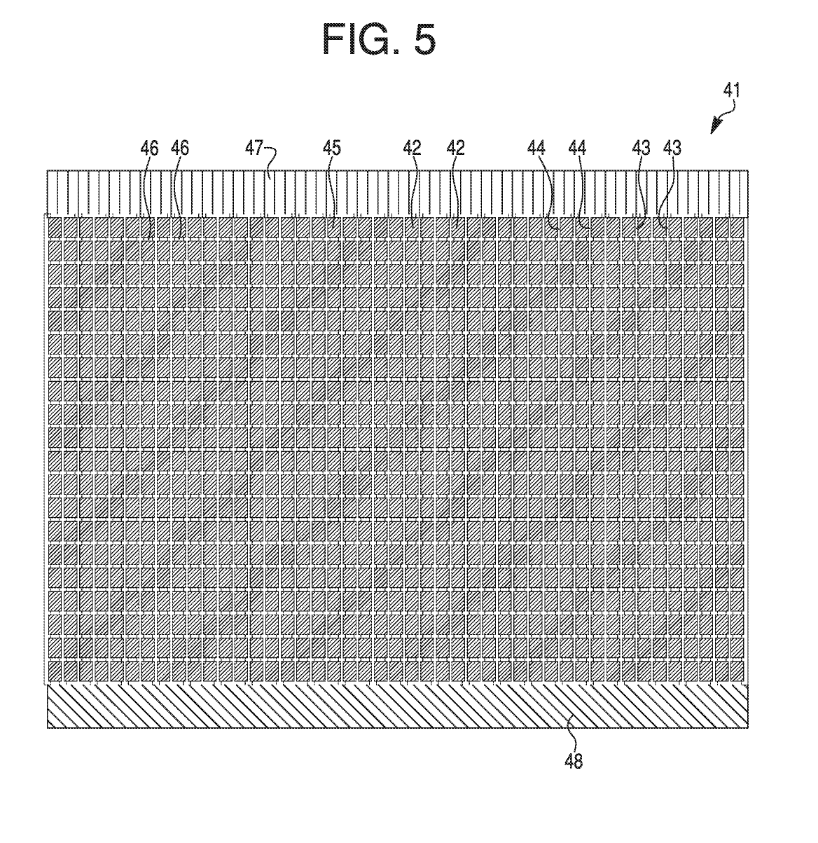

FIG. 5 illustrates a second embodiment of a heater of the type of heater for wearables illustrated in FIG. 4 comprising printed resistive patches with spaces between them, wherein the size of the spaces has been decreased considerably and is a small fraction of the size of the patches. The heater again comprises two printed bus bars, electrodes printed in an interdigitated pattern to provide two sets of finger-like electrodes with one set connected to one bus bar and the other set connected to the other bus bar and an array of patches of printed resistive material all printed on a substrate. The heater 41 is shown with nine hundred individual heaters 42. The individual heaters 42 each comprise two electrodes, one 43 from one set of electrodes and a second 44 from the other set of electrodes, and a patch of resistive material 45. Between each pair of neighboring finger-like electrodes 43 and 44 are a series of the resistive material patches 45 contiguous to both electrodes of the pair. The series of resistive material patches 45 are separated by spaces 46 both along the length of the pairs of neighboring electrodes and between neighboring series of resistive patches. As shown in FIG. 5, the spaces 46 separating the resistive material patches 45 are greatly reduced from those shown in FIG. 4 and the nine hundred resistive material patches are quite close to one another. The small printed patches are more uniform than can be achieved with one large resistive material layer. Bus bars 47 and 48 provide voltage to the two sets of electrodes 43 and 44 respectively.

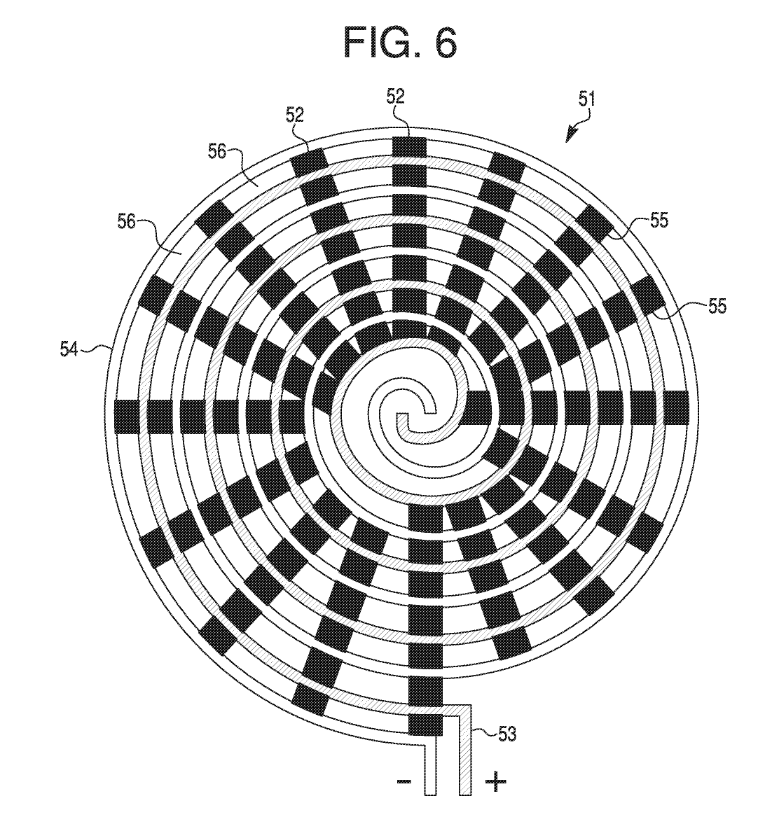

FIG. 6 illustrates a heater for wearables with two spiral electrodes and patches of resistive material printed along a number of radii of the spirals, the heater comprising: two electrodes each in the shape of a spiral winding around a fixed center point with decreasing distance from the outer end of each to the inner end of each and placed so that each spiral is interspaced with respect to the other such that a line from the outer ends of the spirals to the center point intersects first one electrode then the other electrode in alternate fashion and a series of patches of resistive material printed along a number of the lines from the outer ends of the spirals to the center point, herein referred to as radii of the spirals such that each patch is contiguous to the two electrodes. The heater 51 is shown with one hundred eleven individual heaters 52. The individual heaters 52 each comprise the two spiral electrodes 53 and 54 and a patch of resistive material 55 contiguous to both electrodes. There is considerable amount of exposed substrate 56. If the substrate is permeable and breathable the exposed substrate 56 provide a breathable area in the heater. Openings can be made in the area of the exposed substrate to provide breathability.

### EXAMPLES

### Example 1

A heater, as shown in FIG. 4, relatively sparsely populated with resistive patches was made and tested. The substrate used was thermoplastic polyurethane Bemis St-604 (Bemis Associates Inc., Shirley, Mass.) with a thickness of 0.09 mm. Referring to FIG. 4, there were two bus bars 37 and 38 each with a length of 152.4 mm and a width of 20 mm. There were five silver electrode fingers 33 attached to bus bar 37 and another five silver electrode fingers 34 attached to bus bar 38. The length of each electrode finger was 161.2 mm and the width was 3 mm. Between each pairs of adjacent electrode fingers 33 and 34 there were eleven equally spaced resistive patches 35 and there were nine series of such resistive patch groups, making a total number of 99 resistive patches. The dimensions of each resistive patch were 2 mm along the electrode fingers and 13.6 mm between adjacent electrode fingers 33 and 34. The spaces 36 between resistive patches were 12.7 mm long. The total width of the heater including the width of the bus bars was 203.2 mm, and the length of the heater being the same as the length of the bus bar was 152.4 mm.

The resistive patches were printed carbon paste (DuPont™ PE-671, DuPont Co., Wilmington, Del.) with a resistivity of 260 Ohm/sq. The bus bars and electrodes were printed silver paste (DuPont™ PE 874, DuPont Co., Wilmington, Del.) with a resistivity of 0.025 Ohms/sq.

Table 1 shows the maximum temperatures obtained versus voltage applied.

TABLE 1

| Voltage applied (Volts) | Max Temperature (° C.) |
|---|---|
| 1 | 21.5 |
| 6 | 24.8 |
| 9 | 35.8 |
| 12 | 41.9 |
| 15 | 46.6 |
| 18 | 50.7 |
| 20 | 53.1 |

### Example 2

A heater, as shown in FIG. 4, with more densely populated resistive patches than that of Example 1 was made and tested. The substrate used was thermoplastic polyurethane Bemis St-604 (Bemis Associates Inc., Shirley, Mass.) with a thickness of 0.09 mm. Referring to FIG. 4, there were two bus bars 37 and 38 each with a length of 152.4 mm and a width of 20 mm. There were four silver electrode fingers 33 attached to bus bar 37 and another four silver electrode fingers 34 attached to bus bar 38. The length of each electrode finger was 160.5 mm and the width was 3 mm. Between each pairs of adjacent electrode fingers 33 and 34 there were thirtyeight equally spaced resistive patches 35 and there were seven series of such resistive patch groups, making a total of 266 resistive patches. The dimensions of each resistive patch were 2 mm along the electrode fingers and 19.5 mm between adjacent electrode fingers 33 and 34. The spaces 36 between resistive patches were 2.2 mm long. The total width of the heater including the width of the bus bars was 203.2 mm, and the length of the heater was 152.4 mm, the same as the length of the bus bars.

The resistive patches were printed carbon paste (DuPont™ PE-671, DuPont Co., Wilmington, Del.) with a resistivity of 260 Ohm/sq. The bus bars and electrodes were printed silver paste (DuPont™ PE 874, DuPont Co., Wilmington, Del.) with a resistivity of 0.025 Ohms/sq.

Table 2 shows the maximum temperatures obtained versus voltage applied.

TABLE 2

| Voltage applied (Volts) | Max Temperature (° C.) |
|---|---|
| 1 | 22 |
| 6 | 30 |
| 9 | 34.7 |
| 12 | 41.6 |
| 15 | 48.8 |
| 18 | 56.8 |
| 20 | 62.5 |

### Example 3

A heater, as shown in FIG. 4, populated with resistive patches was made and tested. The substrate used was thermoplastic polyurethane Bemis St-604 (Bemis Associates Inc., Shirley, Mass.) with a thickness of 0.09 mm. Referring to FIG. 4, there were two bus bars 37 and 38 each with a length of 152.4 mm and a width of 20 mm. There were five silver electrode fingers 33 attached to bus bar 37 and another five silver electrode fingers 34 attached to bus bar 38. The length of each electrode finger was 161.2 mm and the width was 3 mm. Between each pairs of adjacent electrode fingers 33 and 34 there were fourteen equally spaced resistive patches 35 and there were nine series of such resistive patch groups, making a total number of 126 resistive patches. The dimensions of each resistive patch were 4 mm along the electrode fingers and 13.6 mm between adjacent electrode fingers 33 and 34. The spaces 36 between resistive patches were 7.3 mm long. The total width of the heater including the width of the bus bars was 203.2 mm, and the length of the heater being the same as the length of the bus bar was 152.4 mm.

The resistive patches were printed carbon paste (DuPont™ PE-671, DuPont Co., Wilmington, Del.) with a resistivity of 260 Ohm/sq. The bus bars and electrodes were printed silver paste (DuPont™ PE 874, DuPont Co., Wilmington, Del.) with a resistivity of 0.025 Ohms/sq.

To make this heater breathable, an opening was made at the center of each space 36 between adjacent resistive patches. Each hole had a diameter of 5 mm. There were a total of 117 such holes and they were intentionally located at the center of the spaces 36 so there were no resistive patches or conductive paths affected and the electrical operation of the heater was not disturbed.

Table 3 shows the maximum temperatures obtained versus voltage applied.

TABLE 3

| Voltage applied (Volts) | Max Temperature (° C.) |
|---|---|
| 1 | 22.1 |
| 6 | 33.9 |
| 9 | 41.9 |
| 12 | 51.7 |
| 15 | 62.9 |
| 18 | 74.4 |
| 20 | 82.9 |

What is claimed is:

1. A wearable garment containing a heater on a substrate, the heater comprising a plurality of individual heaters disposed in an array covering at most 90% of the overall area of the heater.

2. The wearable garment of claim 1, the area of the heater not covered by the individual heaters comprising breathable substrate.

3. The wearable garment of claim 1, the plurality of individual heaters disposed in an array covering at most 75% of the overall area of the heater.

4. The wearable garment of claim 1, wherein each individual heater comprises printed electrodes and a printed resistive material to serve as a resistive heating element.

5. The wearable garment of claim 4, wherein the electrodes are printed in an interdigitated pattern to provide two sets of finger-like electrodes with the printed resistive material contiguous to the electrodes.

6. The wearable garment of claim 5, wherein each individual heater further comprises bus bars and the individual heaters are disposed in the manner illustrated in FIG. 1.

7. The wearable garment of claim 6, wherein the printed electrodes and bus bars are silver electrodes and silver bus bars and the printed resistive material is carbon.

8. The wearable garment of claim 5, wherein each individual heater further comprises bus bars and the individual heaters are disposed in the manner illustrated in FIG. 2.

9. The wearable garment of claim 1, the heater comprising:
a) a substrate;
b) electrodes printed in an interdigitated pattern to provide two sets of electrodes consisting of finger-like electrodes each of a given width;
c) two printed bus bars, wherein the first set of electrodes is connected to one bus bar and the second set of electrodes is connected to the other bus bar to provide an array of interdigitated electrodes between the two bus bars; and
d) strips of resistive material printed parallel to the finger-like electrodes, wherein each resistive material strip has a width at least equal to the distance between neighboring electrodes so that each resistive material strip is contiguous to one finger-like electrode from the first set of electrodes and one finger-like electrode from the second set of electrodes and a width no greater than twice the width of a finger-like electrode plus the distance between neighboring electrodes, wherein each resistive material strip extends along the length of the two electrodes to which it is contiguous to form an individual heater with the regions between individual heaters comprising exposed substrate and wherein the electrodes and the bus bars can be printed onto the substrate before or after the resistive material strips.

10. The wearable garment of claim 9, wherein the number of resistive material strips is equal to the number of finger-like electrodes on each set of electrodes.

11. The wearable garment of claim 10, wherein the individual heaters are disposed in the manner illustrated in FIG. 3.

12. The wearable garment of claim 11, wherein the printed electrodes and bus bars are silver electrodes and silver bus bars and the printed strips of resistive material are strips of carbon.

13. The wearable garment of claim 1, the heater comprising: two printed bus bars, electrodes printed in an interdigitated pattern to provide two sets of finger-like electrodes with one set connected to one bus bar and the other set connected to the other bus bar and an array of patches of printed resistive material, wherein between each pair of neighboring finger-like electrodes are a series of the resistive material patches contiguous to both electrodes of the pair, wherein the series of resistive material patches are separated by spaces both along the length of the pairs of neighboring electrodes and between neighboring series of resistive patches and wherein each patch of resistive material and its contiguous electrodes form an individual heater.

14. The wearable garment of claim 13, wherein the spaces separating the resistive material patches are similar in size to the resistive material patches such that the total array of resistive material patches and spaces forms a checkerboard-like pattern.

15. The wearable garment of claim 14, wherein the array of resistive material patches and spaces are disposed in the manner illustrated in FIG. 4.

16. The wearable garment of claim 15, wherein the printed electrodes and bus bars are silver electrodes and silver bus bars and the printed resistive material is carbon.

17. The wearable garment of claim 14, wherein the array of resistive material patches and spaces are disposed in the manner illustrated in FIG. 5.

18. The wearable garment of claim 1, the heater comprising: two electrodes each in the shape of a spiral winding around a fixed center point with decreasing distance from the outer end of each to the inner end of each and placed so that each spiral is interspaced with respect to the other such that a line from the outer ends of the spirals to the center point intersects first one electrode then the other electrode in alternate fashion and a series of patches of resistive material printed along a number of radii of the spirals such that each patch is contiguous to the two electrodes.

19. The wearable garment of claim 18, wherein the printed electrodes are silver electrodes and the printed resistive material is carbon.

20. The wearable garment of claim 18, wherein the array of resistive material patches and spaces are disposed in the manner illustrated in FIG. 6.
